(19) United States
(12) Patent Application Publication
(10) Pub. No.: US 2020/0371461 A1
(43) Pub. Date: Nov. 26, 2020

(54) FUSING DEVICE AND IMAGE FORMING APPARATUS

(71) Applicant: KONICA MINOLTA, INC., Tokyo (JP)

(72) Inventors: Masashi NAKABO, Aichi (JP); Takeru KINOSHITA, Aichi (JP)

(21) Appl. No.: 16/866,230

(22) Filed: May 4, 2020

(30) Foreign Application Priority Data
May 22, 2019 (JP) 2019-095716

(51) Int. Cl. G03G 15/20

(52) U.S. Cl. CPC G03G 15/2064; G03G 15/2028; G03G 15/2053

(57) ABSTRACT

A fusing device includes: a pressure member that forms a paper contact part between the pressure member and a heating member; and a guide member disposed in the vicinity of the pressure member on the other side of which the paper contact part is formed. The guide member has a first guide wall and an outlet. The first guide wall is disposed in the close proximity of the peripheral surface of the pressure member on the other side of which the paper contact part is formed. The outlet allows cooling air to go away from the pressure roller. The cooling air is supplied from a fan then comes downstream through a passage formed by the first guide wall. The guide member is configured such that a distance between the first guide wall and the pressure member is the shortest at a most downstream part of the passage.

### BACKGROUND

### Technological Field

The present invention relates to: a fusing device to be used in an image forming apparatus such as a copier or printer; and an image forming apparatus provided with this fusing device.

### Description of the Related Art

Heat roller fusing devices are widely used in copiers, printers, facsimiles, or electrophotographic image forming apparatuses such as multi-function apparatuses having copier, printer, and facsimile functions for their convenience. Such a heat roller fusing device is provided with: a fusing belt to be heated by a heater such as a halogen lamp; a heating member such as a fusing roller; and a pressure member such as a pressure roller. The heat roller fusing device forms a nip region by pressing the pressure member to the heating member and fuses toner images onto a recording material by applying heat and pressure to the nip region.

When the fusing device receives small-sized sheets of paper one after another, no significant rise in temperature occurs in a paper contact part of the heating and pressure member because paper take heat from the heating member; the paper contact part ranges in a lengthwise direction of the heating and pressure member. In contrast, a significant rise in temperature occurs at the both lengthwise ends of the heating and pressure member, specially in the vicinity of the both widthwise ends of the paper, because these parts do not come in contact with paper. This may cause a damage to functional members and a large number of ultra-fine particles (UFP) from the damaged members.

To avoid a local significant rise in the temperature of the heating and pressure member, a thermal equalizer roller can be used in a fusing device; such a fusing device is allowed to smooth out the lengthwise temperature of the pressure roller and other members by pressing the thermal equalizer roller in contact with the pressure roller. To avoid a local rise in the temperature of the same, the fusing device also decreases productivity by pulse-phase modulation (PPM).

Every time when the thermal equalizer roller comes in physical contact with the pressure roller, the pressure roller is damaged by paper and toner dust, and the lives of the pressure roller and other members thus become shorter. Furthermore, the fusing device takes time to complete printing with a lower productivity by PPM, making the user wait longer.

Japanese Unexamined Patent Application Publication No. 2016-006472 suggests a technique of cooling down the pressure member with cooling air supplied from an exhaust fan. Specifically, it is a fusing device 1 provided with a cooling mechanism 45 and a retractor that retracts the pressure member 6 from a fusing position 10 to a standby position. The cooling mechanism 45 has air guide plates 20 and 22 that allow cooling air 44 to flow along the pressure member 6 then go outside regardless of whether or not the pressure member 6 is retracted by the retracting means.

The technique described in Japanese Unexamined Patent Application Publication No. 2016-006472, however, has room for improvement in cooling efficiency because it simply allows cooling air to flow to the pressure member, on the other side of which the paper contact part is formed. In other words, it does not allow cooling air to flow along the pressure roller, failing in cooling down the pressure member efficiently with a limited cooling area.

### SUMMARY

The present invention, which has been made in consideration of such a technical background as described above, relates to a fusing device that cools down a pressure member with cooling air, being aimed at providing a fusing device and an image forming apparatus that are capable of cooling down the pressure member efficiently with a limited cooling area.

A first aspect of the present invention relates to a fusing device including:

a pressure member that forms a paper contact part between the pressure member and a heating member, the pressure member being capable of rotating; and

a guide member disposed in the vicinity of the pressure member on the other side of which the paper contact part is formed,

wherein the guide member has a first guide wall and an outlet, the first guide wall being disposed in the close proximity of the peripheral surface of the pressure member on the other side of which the paper contact part is formed, the first guide wall forming a passage for cooling air to pass through, the cooling air being supplied from a fan to cool down the pressure roller, the outlet allowing the cooling air to go away from the pressure roller, the cooling air coming downstream through the passage, and

wherein the guide member is configured such that a distance between the first guide wall and the pressure member is the shortest at a most downstream part of the passage.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic diagram illustrating a configuration of an image forming apparatus that is provided with a fusing device according to one embodiment of the present invention.

FIG. 2 is a cross section of the vicinity of the fusing device of the image forming apparatus as viewed from the front.

FIG. 3 is a cross section of the vicinity of the fusing device of the image forming apparatus as viewed from the right in FIG. 2.

FIG. 4 is an enlarged cross section of the fusing device as viewed from the front.

FIG. 5A is a perspective view of a first guide member disposed at the left end of a pressure roller 32 as viewed from obliquely above in FIG. 3; FIG. 5B is a perspective view of the same as viewed from obliquely below in FIG. 3.

FIG. 6A is a perspective view of a second guide member disposed at the right end of the pressure roller 32 as viewed from obliquely above in FIG. 3; FIG. 6B is a perspective view of the same as viewed from obliquely below in FIG. 3.

FIG. 7 is a cross section of a first guide member 36 along the line VII-VII indicated in FIG. 5A when it is mounted at a predetermined position.

FIG. 8 is a cross section of the first guide member 36 along the line VIII-VIII indicated in FIG. 5A when it is mounted at a predetermined position.

FIG. 9 is a view for reference in describing the angle at which cooling air coming through an air duct flows into a passage between the pressure roller and the guide member.

FIG. 10 is a plane view of the fusing device as viewed from the left in FIG. 2, for reference in describing another embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

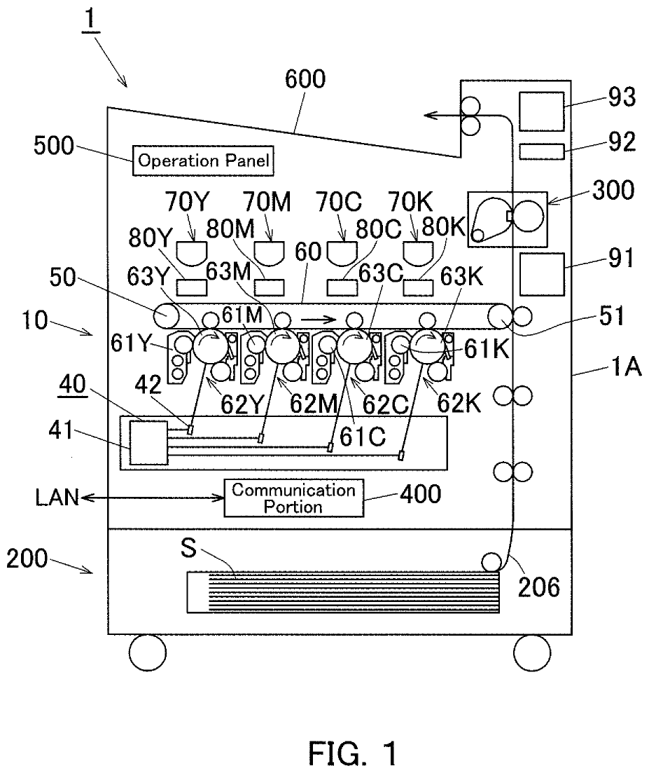

FIG. 1 is a schematic diagram illustrating a configuration of an image forming apparatus 1 that is provided with a fusing device according to one embodiment of the present invention. In this embodiment, a tandem color printer is employed as the image forming apparatus 1.

As referred to FIG. 1, the image forming apparatus 1 has a main body 1A; the main body 1A has a paper feeder 200 in its lower region, a color imaging device 10 in its middle region, and a paper output tray 600 in its upper region. The paper feeder 200 and the paper output tray 600 are connected by a paper conveyance path 206 that conveys upward paper S fed by the paper feeder 200.

The color imaging device 10 is provided with: rollers 50 and 51 as a pair; an intermediate transfer belt 60; and photoconductor units 62C, 62M, 62Y, and 62K constituting imaging units of cyan (C), magenta (M), yellow (Y), and black (K). The rollers 50 and 51 are positioned vertically about in the middle region of the main body 1A; the intermediate transfer belt 60 is looped over the rollers 50 and 51 in an elliptic form having two horizontal lines and run in a direction indicated by the arrow; the photoconductor units 62C, 62M, 62Y, and 62K are positioned along the intermediate transfer belt 60.

After forming toner images, the photoconductor units 62C, 62M, 62Y, and 62K transfer the toner images one by one onto the intermediate transfer belt 60. When the paper S reaches the roller 51 (on the right of the belt in this figure) along the paper conveyance path 206, the toner images on the intermediate transfer belt 60 are transferred onto the paper S as a second transfer process. The paper S is then conveyed to the fusing device 30 to have the toner images fused thereon. Furthermore, an exhaust fan 91 is disposed below the fusing device 300, and a suction fan 92 and a filter device 93 are disposed above the fusing device 300. The fusing device 300, the exhaust fan 91, and the suction fan 92 will be later described.

The photoconductor units 62C, 62M, 62Y, and 62K conduct imaging by the method of electrostatic copying, and are provided with: development portion 61C, 61M, 61Y, and 61K; and photosensitive drums 63C, 63M, 63Y, and 63K, respectively. Each photoconductor unit is further provided with an electrifier, a transcriber, and the like. These components are arranged on the periphery of their corresponding photoconductor. The main body 1A is further provided with a luminous section 40; the luminous section 40 is essentially provided with: a print head 41 having four laser diodes, four polygon mirrors, and four scanning lenses; and four reflective mirrors 42. While the photosensitive drums 63C, 63M, 63Y, and 63K are charged by the electrifier, their corresponding laser diodes emit light to the surfaces of the photosensitive drums 63C, 63M, 63Y, and 63K to form latent images thereon.

The main body 1A is further provided with: toner cartridges 70C, 70M, 70Y, and 70K; and sub-hoppers 80C, 80M, 80Y, and 80K, which serve as a supply mechanism for supplying toner to the development portions 61C, 61M, 61Y, and 61K of the photoconductor units 62C, 62M, 62Y, and 62K. The toner cartridges 70C, 70M, 70Y, and 70K and the sub-hoppers 80C, 80M, 80Y, and 80K are positioned above the photoconductor units 62C, 62M, 62Y, and 62K.

In FIG. 1, a communication portion 400 performs communication with external apparatuses through a network such as a LAN, and an operation panel 500 is provided with a keyboard and a display.

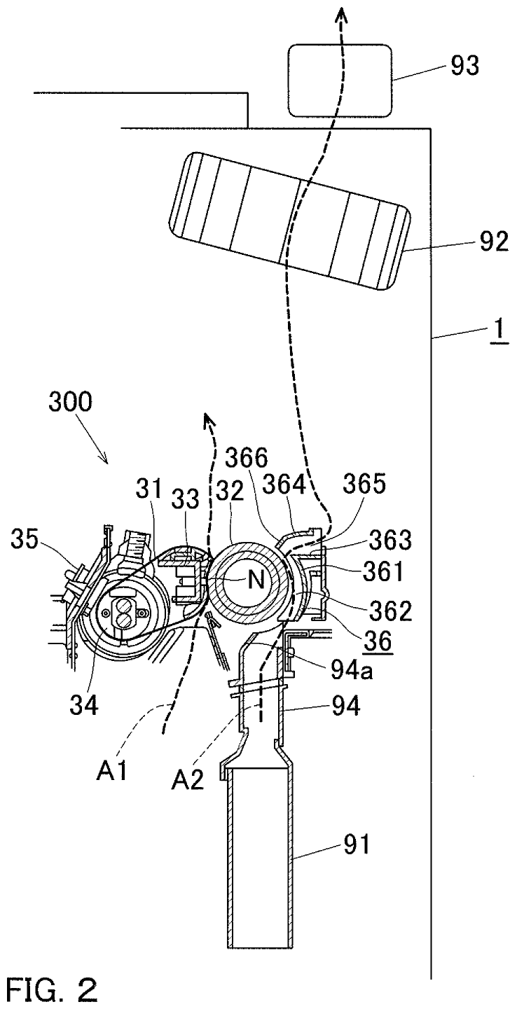

Hereinafter, the fusing device 300 will be described in detail with reference to FIGS. 2 to 4.

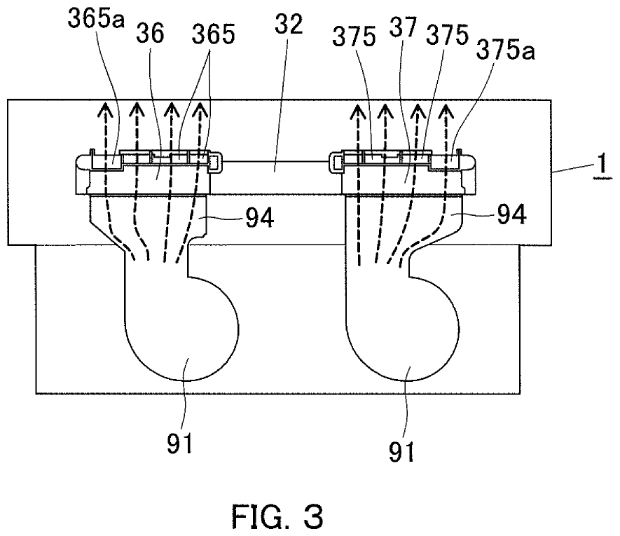

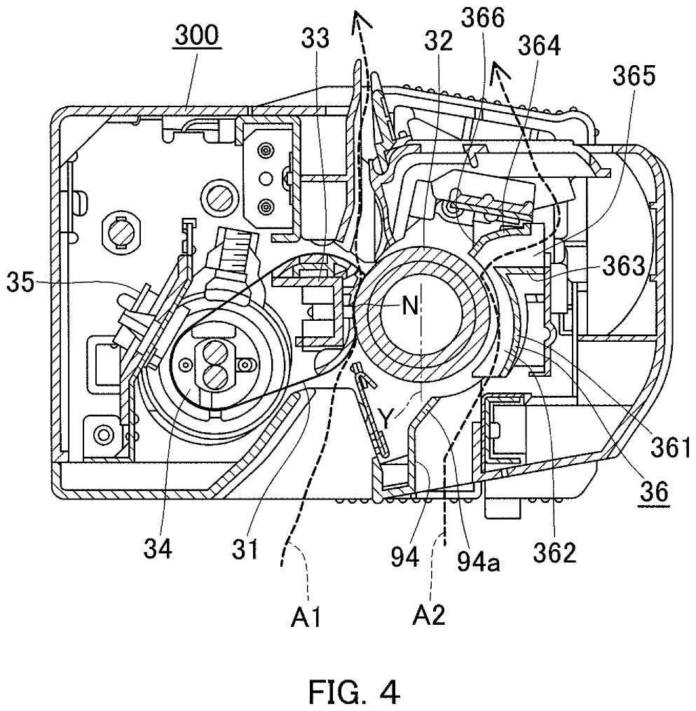

FIG. 2 is a cross section of the vicinity of the fusing device 300 of the image forming apparatus 1 as viewed from the front; FIG. 3 illustrates the vicinity of the fusing device 300 of the image forming apparatus 1 as viewed from the right in FIG. 2; and FIG. 4 is an enlarged cross section of the fusing device 300 as viewed from the front.

As referred to FIG. 2, and as referred to FIG. 4 for more detail, the fusing device 300 is provided with: a fusing belt 31; a pressure roller 32 corresponding to a pressure member; and a fixed member 33 that is constituted by a pad. The fixed member 33 and the pressure roller 32 are disposed adjacent to each other. The fusing belt 31 is looped over a driven roller 34 and the fixed member 33 such that it runs between the fixed member 33 and the pressure roller 32 while being pressed by the pressure roller 32. The pressure roller 32 rotates clockwise as indicated in FIG.

2, making the fusing belt 31 circulate around the driven roller 34 and the fixed member 34.

The driven roller 34 has a heating device not shown in the figure; while fusing is in process, the heating device heats up the driven roller 34, and the driven roller 34 conducts heat to the fusing belt 31. Furthermore, a thermo-sensor 35 that senses the temperature of the fusing belt 31 is disposed in the vicinity of the driven roller 34, on the other side of which the pressure roller 32 is disposed.

While fusing is in process, the above-described configuration allows the paper S to: go downstream (upward in FIGS. 2 and 4) as indicated by a dashed line arrow Al; enter a paper contact part (nip region) N formed between the fusing belt 31 and the pressure roller 32; have toner images fused thereto by the fusing belt 31 and the pressure roller 32; and go further downstream (upward in FIGS. 2 and 4).

As referred to FIGS. 2 to 4, a first guide member 36 and a second guide member 37 are disposed in the vicinity of the peripheral surface of the pressure roller 32, on the other side of which the paper contact part N is formed. The first guide member 36 and the second guide member 37 have the function of allowing cooling air supplied from the exhaust fan 91 to flow along the peripheral surface of the pressure roller 32 then go outside. As referred to FIG. 3, two guide members are provided: the first guide member 36 and the second guide member 37 are disposed at different lengthwise ends of the pressure roller 32.

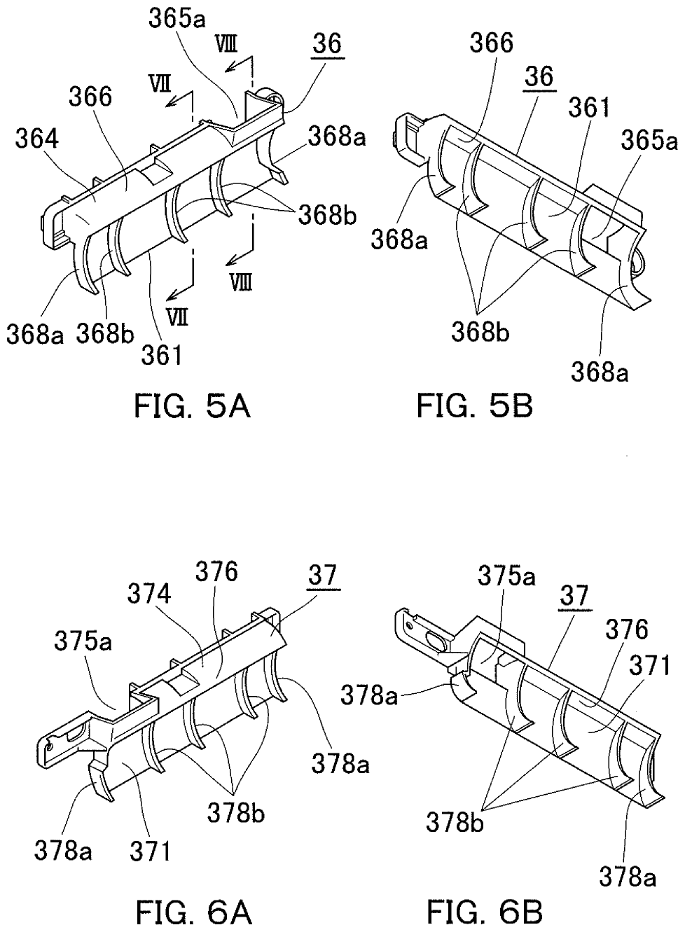

The configurations of the first guide member 36 and the second guide member 37 will be described in detail with reference to FIGS. 5 to 7.

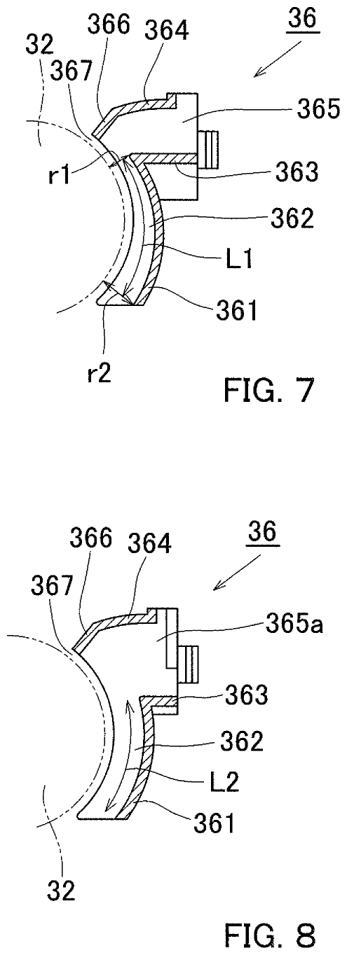

FIG. 5 illustrates the first guide member 36 disposed at the left end of the pressure roller 32 of FIG. 3; FIG. 6 illustrates the second guide member 37 disposed at the right end of the pressure roller 32 of FIG. 3. FIGS. 5A and 5B are perspective views of the first guide member 36 and the second guide member 37, respectively, as viewed from obliquely above; FIGS. 6A and 6B are perspective views of the same, respectively, as viewed from obliquely below. FIG. 7 is a cross section of the first guide member 36 along the line VII-VII indicated in FIG. 5A when it is mounted at a predetermined position; FIG. 8 is a cross section of the same along the line VIII-VIII indicated in FIG. 5A when it is mounted at a predetermined position.

As referred to FIGS. 5 to 7, the first guide member 36 is provided with a first guide wall 361 that is a vertical wall ranging in a lengthwise direction of the pressure roller 32. The first guide wall 361 is curved such that the inner periphery matches the peripheral surface of the pressure roller 32. As referred to FIG. 4, the first guide wall 361 is disposed in the close proximity of the peripheral surface of the pressure roller 32, on the other side of which the paper contact part N is formed with respect to a perpendicular Y running at right angles to the axis of the pressure roller 32. The first guide wall 361 thus serves to keep some clearance between the first guide wall 361 and the pressure roller 32 as a passage 362 through which cooling air flows to the pressure roller 32 from below to above.

The distance between the first guide wall 361 and the pressure roller 32, in other words, the width of the passage 362 will be described. As referred to FIG. 7, the first guide wall 361 has a cross section in the shape of a curve such that: (i) the width of the passage 362 is the longest at the most upstream part, i.e. a distance r2 between the lower most part of the first guide wall 361 and the pressure roller 32 is the longest; (i) the distance gradually becomes shorter downstream (upward in FIG. 7); and (iii) the width of the passage 362 is the shortest at the most downstream part, i.e. a distance r1 between the upper most part of the first guide wall 361 and the pressure roller 32 is the shortest.

The first guide member 36 has a horizontal wall 363 at the upper end of the first guide wall 361; the horizontal wall 363 extends out away from the pressure roller 32 and ranges nearly from end to end in a lengthwise direction of the first guide member 36. The first guide member 36 further has a second guide wall 364 above the horizontal wall 363; the second guide wall 364 extends toward the pressure roller 32 over the first guide wall 363.

An outlet 365 is formed between the horizontal wall 363 and the second guide wall 364; the outlet 365 is oriented to allow cooling air coming through the passage 362 to go outside, away from the paper contact part N of the pressure roller 32.

Furthermore, as referred to FIGS. 7 and 8, the distance between the horizontal wall 363 and the second guide wall 364 at a lengthwise end of the first guide member 36 (the right end in FIGS. 5A and 5B) is the longest in a lengthwise direction of the first guide member 36. Accordingly, the end area of the outlet 365a at a lengthwise end of the first guide member 36 is the largest in a lengthwise direction of the first guide member 36. Therefore, the length L2 of the passage 362 in the vicinity of the outlet 365a having a large end area is shorter than the length L1 of the passage 362 in the vicinity of the outlet 365 having a small end area. In order to reduce the leakage of cooling air toward the fusing belt 31, it is preferred that the length L1 of the passage 362 be half the perimeter of the pressure roller 32 or or less.

The outlet 365a at a lengthwise end of the first guide member 36 illustrated in FIGS. 5A and 5B is open upward. When the first guide member 36 is mounted in the fusing device 300 as illustrated to FIG. 8, the outlet 365a is closed with the second guide wall 364 that is independent of the first guide member 36. Alternatively, the outlet 365a may be still open upward without being closed with anything or may be closed with the second guide wall 364 that is an integral part of the first guide member 36.

The first guide member 36 further has a windbreak wall 366; the windbreak wall 366 extends seamlessly from the second guide wall 364 toward the pressure roller 32 and ranges nearly from end to end in a lengthwise direction of the first guide member 36. The windbreak wall 366 serves to block air coming up through the passage 362. When the first guide member 36 is disposed in the close proximity of the pressure roller 32, the windbreak wall 366 extends out nearly at right angles to the peripheral surface of the pressure roller 32. The edge of the windbreak wall 366 is disposed in the close proximity of the peripheral surface of the pressure roller 32, on the other side of which the paper contact part N is formed with respect to the perpendicular Y running at right angles to the axis of the pressure roller 32. The edge of the windbreak wall 366 has only a small clearance 367 away from the peripheral surface of the pressure roller 32. In order to reduce the leakage of cooling air from the clearance 367, it is preferred that the length of the clearance 367 be as small as possible, less than the distance r1 between the upper most part of the first guide wall 361 and the pressure roller 32. The second guide wall 364 serves to guide the cooling air, blocked by the windbreak wall 336, to the outlet 365.

The first guide member 36 further has block parts 368a at different lengthwise ends; the block parts 368a block up the passage 362 and the outlet 365. The block parts 368a are arch-shaped such that their inner peripheral edges match the peripheral surface of the pressure roller 32. The first guide wall 361 further has multiple partition parts 368b on its inner periphery; the partition parts 368b are arranged on the inner periphery of the first guide wall 361 in a lengthwise direction of the pressure roller 32. The partition parts 368b partition off the passage 362 and the outlet 365. The partition parts 368b are arch-shaped such that their inner peripheral edges match the peripheral surface of the pressure roller 32. There may be one the partition part 368b or may not have any the partition part 368b.

The first guide member 36, having the above-described configuration, is disposed in the close proximity of the pressure roller 32, on the other side of which the paper contact part N is formed. The outlet 365a, having a large end area, is disposed at a lengthwise end of the pressure roller 32 i.e. the left lengthwise end of the pressure roller 32 (as viewed in FIG. 3). In the first guide member 36, the inner peripheral edges of the block parts 368a, the inner peripheral edges of the partition parts 368b, and the edge of the windbreak wall 366 have only a small clearance away from the peripheral surface of the pressure roller 32. The passage 362, having a curved cross section, is formed between the peripheral surface of the pressure roller 32 and the first guide wall 361 of the first guide member 36. The passage 362 ranges in a lengthwise direction of the pressure roller 32 from end to end in a lengthwise direction of the guide member 36. Furthermore, the passage 362 is partitioned off in multiple sections by the partition parts 368b, which are arranged in a lengthwise direction of the pressure roller 32.

Herein, a detailed description of the second guide member 37 illustrated in FIG. 6 is omitted because the only difference from the first guide member 36 illustrated in FIG. 5 is that its configuration is symmetrical to that of the first guide member 36. The second guide wall 37 has: a first guide wall 371; a passage 372; a horizontal wall 373; a second guide wall 374; outlets 375 and 375a; a windbreak wall 376; a block part 378a; and a partition part 378b, which respectively correspond to: the first guide wall 361; the passage 362; the horizontal wall 363; the second guide wall 364; the outlets 365 and 365a; the windbreak wall 366, the block part 368a; and the partition part 368b of the first guide member 36. The first guide member 36 and the second guide member 37 are disposed symmetrically with respect to the lengthwise center of the pressure roller 32. So, the first guide member 37 is disposed in the close proximity of the pressure roller 32, on the other side of which the paper contact part N is formed. The outlet 375a, having a large end area, is disposed at a lengthwise end of the pressure roller 32 i.e. the right lengthwise end of the pressure roller 32.

Two exhaust fans are provided in the vicinity of the fusing device 300: the exhaust fan 91 is disposed below the first guide member 36 and below the second guided member 37 such that cooling air is supplied upward. Furthermore, an air duct 94 is disposed between the exhaust fan 91 and the first guide member 36 and between the exhaust fan 91 and the second guide member 37 such that cooling air supplied from the exhaust fans 91 flow into the passage 362 of the first guide member 36 and the passage 372 of the second guide member 37, by way of the air ducts 94.

Although not shown in the figures, shutters are disposed in the vicinity of the exit of the air duct 94. The shutters can be individually closed and opened depending on the width of the paper S, allowing cooling air to flow as appropriate into either or both of the passages 362 and 372, which are partitioned off by the partition parts 368b and 378b. This allows more efficient cooling control depending on the width of the paper S. In the description below, however, it is assumed that all the shutters are opened to allow as much cooling air as possible into both of the passages 362 and 372.

Two suction fans are provided outside the fusing device 300: the suction fan 92 is disposed above the first guide member 36 and above the second guide member 37. The suction fans 92 serve to guide to the filtering device 93 the cooling air, coming out from the outlets 365, 365a, 375, and 375a after passing through the passages 362 and 372. The suction fans 92 further serves to discharge the cooling air, stained by the filtering device 93, outside the image forming apparatus 1. Instead of the suction fans 92, two discharge guide passages may be provided; one discharge passage guides to the filtering device 93 the cooling air coming out from the outlets 365 and 365a of the first guide member 36, and the other discharge passage guides to the filtering device 93 the cooling air coming out from the outlets 375 and 375a of the second guide member 37.

Hereinafter, an effect of the first guide member 36 will be described; the description of the second guide member 37 will be omitted since its effect is the same as that of the first guide member 36.

While the fusing device 300 is in operation, the temperature of the fusing belt 31 is maintained at a certain level with the thermo-sensor 35. The fusing belt 31 allows the paper S, coming through a paper conveyance path 206 with toner images formed thereon, to pass through the paper contact part N between the fusing belt 31 and the pressure roller 32. The fusing belt 31 then fuses the toner images onto the paper S and discharges the paper S outside the image forming apparatus 1 onto the paper output tray 600.

When the fusing device 300 receives, for example, small-sized sheets of the paper S one after another, a significant rise in temperature occurs at the both lengthwise ends of the pressure roller 32 and other members, specially in the vicinity of the both widthwise ends of the paper S, because these parts do not come in contact with the paper S.

The exhaust fan 91 and the suction fan 92 start running at an appropriate time while the fusing device 300 is in operation; cooling air is thus supplied upward through the air duct 94, flowing into the passage 362 from below the first guide member 36. Subsequently, the cooling air further flows upward through the passage 362, which is curved to match the peripheral surface of the pressure roller 32. In this upward-flowing process, the peripheral surface of the pressure roller 32 is subjected to the cooling air, and the cooling air cools down the peripheral surface of the pressure roller 32 by taking heat therefrom.

As described above, the first guide member 36 is configured such that the width of the passage 362 is the shortest at the most downstream part, i.e. the distance r1 between the first guide wall 361 and the pressure roller 32 is the shortest. The cooling air thus flows the fastest at the most downstream part of the passage 362, resulting in that the pressure roller 32 is subjected to much fresh air at that point. Furthermore, the pressure roller 32 rotates upstream of the passage 362; this means, after being heated by the fusing belt 31, the peripheral surface of the pressure roller 32 passes through the most downstream part of the passage 362 prior to the most upstream part of the passage 362. Specifically, a peripheral area of the pressure roller 32 is subjected to much fresh air quickly after being heated. This allows cooling down the pressure roller 32 efficiently with a limited cooling area.

Furthermore, the first guide member 36 is configured such that: the width of the passage 362 is the longest at the most upstream part that is the entry of cooling air, i.e. the distance r2 between the first guide wall 361 and the pressure roller 32 is the longest; and the distance becomes gradually shorter downstream of the passage 362. The cooling air thus flows faster downstream of the passage 362 and air resistance is little enough to collect air to the periphery surface of the pressure roller 32. This allows further improvement in cooling efficiency.

Furthermore, the passage 362 is partitioned off into multiple sections by the partition parts 368b, which are arranged in a lengthwise direction of the first guide member 36. The cooling air thus flows along the peripheral surface of the pressure roller 32, passing through each section of the passage 362 smoothly without causing a turbulent flow. This allows further improvement in cooling efficiency.

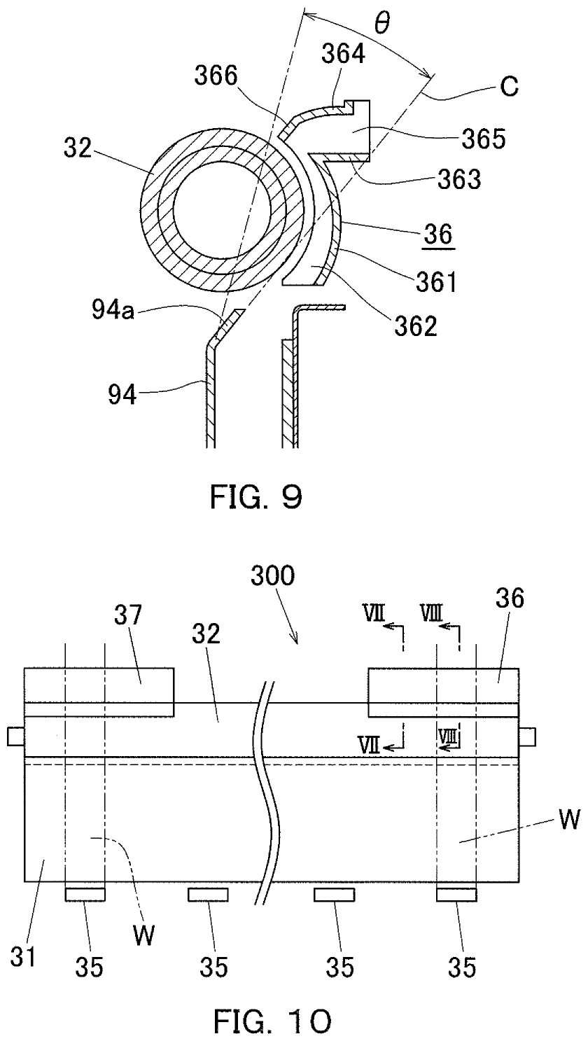

For a better cooling efficiency, it is preferred that the cooling air, supplied through the air duct 94 from the exhaust fan 91, flow into the passage 362 at an appropriate angle. Specifically, it is preferred that the angle of inclination θ of an upper inclined part 94a of the air duct 94, which determines an angle at which the cooling air flows into the passage 362, be oriented at 0 to 50 degrees counterclockwise with respect to a tangent C to the pressure roller 32, as viewed in FIG. 9. When the angle of inclination θ is less than 0 degrees, cooling efficiency will go down. When the angle of inclination θ is more than 50 degrees, cooling efficiency also will go down because an air flow is dispersed by hitting a lower peripheral surface of the pressure roller 32; not only that, the cooling air will leak toward the fusing belt 31 through the clearance between the pressure roller 32 and the air duct 94, interfering with control of the temperature of the fusing belt 31. FIG. 9 illustrates the upper inclined part 94a of the air duct 94 when the angle of inclination θ is 0 degrees.

The cooling air, supplied upward and downstream of the passage 362, is blocked by the windbreak wall 366, extending out nearly at right angles to the peripheral surface of the pressure roller 32. The cooling air is then guided to the outlets 365 and 365a by the second guide wall 364, seamlessly extended from the windbreak wall 362. The edge of the windbreak wall 366 is disposed in the close proximity of the pressure roller 32, on the other side of which the paper contact part N is formed with respect to the perpendicular Y running through the axis of the pressure roller 32. The windbreak wall 366 extends out nearly at right angles to the peripheral surface of the pressure roller 32. The clearance 367 between the windbreak wall 366 and the pressure roller 32 is narrower than the most downstream width of the passage 362 i.e. the distance r1 between the first guide wall 361 and the pressure roller 32. This allows reducing the leakage of the cooling air, blocked by the windbreak wall 366, toward the fusing belt 31 by way of the clearance 367 between the windbreak wall 366 and the pressure roller 32. Furthermore, a certain size of space is created between the most downstream part of the passage 362 and the windbreak wall 366; and the cooling air, blocked by the windbreak wall 366, causes a turbulent flow in this space. This allows further reducing the leakage of the cooling air toward the fusing belt 31 by way of the clearance 367 between the windbreak wall 366 and the pressure roller 32.

Furthermore, the outlets 365 and 365a are oriented away from the pressure roller 32. The second guide wall 364 allows the cooling air, blocked by the windbreak wall 366, to go out from the outlets 365 and 365a, away from the pressure roller 32. This allows further reducing the leakage of the cooling air toward the fusing belt 31 by way of the clearance 367 between the windbreak wall 366 and the pressure roller 32. Furthermore, in this embodiment, the length L1 of the passage 362, extending in a peripheral direction of the pressure roller 32, is half the perimeter of the pressure roller 32 or less. This allows further reducing the leakage of the cooling air toward the fusing belt 31.

Furthermore, in this embodiment, the guide members 36 and 37 are disposed at the different lengthwise ends of the pressure roller 32, symmetrically with respect to the lengthwise center of the pressure roller 32. Since no guide member is disposed at the lengthwise center of the pressure roller 32, the lengthwise center of the pressure roller 32 is not subjected cooling air. The reason for this will be described below.

When the paper S passes through, the lengthwise center of the pressure roller 32 comes in contact with the paper S instead of being in physical contact with the fusing belt 31. So, when small-sized sheets of the paper S pass through the paper contact part N one after another, no significant rise in temperature occurs at the lengthwise center of the pressure roller 32, and thus these parts do not need to be cooled down. In contrast, when small-sized sheets of paper pass through the paper contact part N one after another, a significant rise in temperature occurs at the both lengthwise ends of the pressure roller 32 because these parts come in physical contact with the fusing belt 31 instead of the paper S. Specially, a very significant rise in temperature occurs in the vicinity of the both widthwise ends of the small-sized sheets of the paper S. To solve this problem, the first guide member 36 and the second guide member 37 are disposed at the different lengthwise ends of the pressure roller 32 such that the vicinity of the both widthwise ends of the small-sized sheets of the paper S is intensively cooled down. While the vicinity of the both widthwise ends of the paper S, at which a significant rise in temperature occurs is cooled down, the unnecessary function of cooling down the lengthwise center of the pressure roller 32, at which no significant rise in temperature occurs is eliminated. This allows further improvement in cooling efficiency.

Furthermore, as described above, the temperature of the pressure roller 32 at the both lengthwise ends of the pressure roller 32 is lower than that in the vicinity of the both widthwise ends of the paper S. To solve this problem, in this embodiment, the outlet 365a at the outer lengthwise end of the first guide member 36 has an end area larger than that of the outlet 365 at the inner lengthwise end of the first guide member 36 (a position less distant to the lengthwise center of the pressure roller 32) such that the cooling air, supplied to the outer lengthwise end of the first guide member 36, at which a lower rise in temperature occurs, quickly goes out from the outlet 365a having a large end area. This allows further reducing the leakage of the cooling air toward the fusing belt 31. The outlet 365 at the inner lengthwise end has an end area smaller than that of the outlet 365a at the outer lengthwise end, and the length L1 of the passage 362 at the inner lengthwise end is thus longer than the length L2 of the passage 362 at the outer lengthwise end. This allows maintaining high cooling efficiency at the inner lengthwise end.

FIG. 10 is a plane view of the fusing device 300 as viewed from the left in FIG. 2, for reference in describing another embodiment of the present invention. In this embodiment, thermo-sensors 35 are arranged in a widthwise direction of the fusing belt 31. The outlet 365a, having a large end area as illustrated in FIG. 8, is located in a range W of the first guide member 36, which includes the thermo-sensor 35; the outlet 365, having a small end area as illustrated in FIG. 7, is located in a range of the first guide member 36, which does not include the thermo-sensor 35. When the outlet 365a, having a large end area, is located in the range W including the thermo-sensor 35, the cooling air goes out from the outlet 365a quickly after cooling down the pressure roller 32. This allows the leakage of the cooling air toward the thermo-sensor 35. The second guide member 37 has an identical configuration with that of the first guide member 36.

While some embodiments of the present invention have been described in detail herein, it should be understood that the present invention is not limited to these embodiments. For example, in the above-described fusing device 300, the fusing belt 31 and the pressure roller 32 form the paper contact part N. Alternatively, a heating roller and the pressure roller 32 may form the paper contact part N.

Although one or more embodiments of the present invention have been described and illustrated in detail, the disclosed embodiments are made for purposes of illustration and example only and not limitation. The scope of the present invention should be interpreted by terms of the appended claims.

What is claimed is:

1. A fusing device comprising:
a pressure member that forms a paper contact part between the pressure member and a heating member, the pressure member being capable of rotating; and
a guide member disposed in the vicinity of the pressure member on the other side of which the paper contact part is formed,
wherein the guide member has a first guide wall and an outlet, the first guide wall being disposed in the close proximity of the peripheral surface of the pressure member on the other side of which the paper contact part is formed, the first guide wall forming a passage for cooling air to pass through, the cooling air being supplied from a fan to cool down the pressure roller, the outlet allowing the cooling air to go away from the pressure roller, the cooling air coming downstream through the passage, and
wherein the guide member is configured such that a distance between the first guide wall and the pressure member is the shortest at a most downstream part of the passage.

2. The fusing device according to claim 1, wherein the guide member is configured such that the distance between the first guide wall and the pressure member becomes gradually shorter downstream of the passage.

3. The fusing device according to claim 1, wherein the guide member has a windbreak wall and a second guide wall, the windbreak wall extending out nearly at right angles to the peripheral surface of the pressure member, the windbreak wall blocking the cooling air coming downstream through the passage, the second guide wall seamlessly extending from the windbreak wall, the second guide wall allowing the cooling air to flow to the outlet, the cooling air being blocked by the windbreak wall.

4. The fusing device according to claim 1, wherein a clearance between the windbreak wall and the pressure roller is narrower than the distance between the first guide wall and the pressure roller at the most downstream part of the passage.

5. The fusing device according to claim 1, wherein the cooling air supplied from the fan flows into the passage at an angle of 0 to 50 degrees with respect to a tangent to the pressure roller.

6. The fusing device according to claim 1, wherein a length of the passage is half a perimeter of the pressure member or less, the passage extending in a peripheral direction of the pressure member.

7. The fusing device according to claim 1, wherein the outlet is oriented to allow the cooling air to go away from the pressure member.

8. The fusing device according to claim 1, wherein two the guide members are disposed at different lengthwise ends of the pressure member, symmetrically with respect to a lengthwise center of the pressure member.

9. The fusing device according to claim 1, wherein a length of the passage at a lengthwise end of the pressure member is shorter than that at a position less distant to a lengthwise center of the pressure member, the passage extending in a peripheral direction of the pressure member.

10. The fusing device according to claim 1, wherein the first guide wall has one or more partition parts arranged in a lengthwise direction of the pressure roller, the one or more partition parts partitioning off the passage.

11. The fusing device according to claim 1,
wherein the outlets are formed in a lengthwise direction of the pressure roller and the outlets have end areas in different sizes depending on ranges in which the outlets are located, the ranges being first and second ranges arranged in a lengthwise direction of the pressure member, and
wherein either or both of the conditions are satisfied: i) the outlet in the first range has an end area larger than that in the second range not including a thermo-sensor disposed in the vicinity of the paper contact part of the pressure member, the first range including the thermo-sensor; and ii) the outlet at a lengthwise end of the pressure roller has an end area larger than that at a widthwise end of paper.

12. The electronic apparatus according to claim 1, further comprising a guide passage or an air sucker that allows the cooling air to flow to a filtering device provided outside the fusing device, the filtering device straining the cooling air, the cooling air being exhausted from the outlet.

13. An image forming apparatus comprising:
the fusing device according to claim 1; and
a fan that cools down a pressure member by supplying cooling air, the pressure member being provided in the fusing device.

14. The image forming apparatus according to claim 13, further comprising a filtering device that strains the cooling air, the cooling air being exhausted from the outlet, the outlet being formed by a guide member provided in the fusing device.
